(19) United States
(12) Patent Application Publication
(10) Pub. No.: US 2025/0287301 A1
(43) Pub. Date: Sep. 11, 2025

(54) WIRELESS NETWORK ENERGY SAVINGS

(71) Applicant: DISH Wireless L.L.C., Englewood, CO (US)

(72) Inventors: Dhaval Mehta, Aldie, VA (US); Gurpreet Sohi, Parker, CO (US); Sourabh Gupta, Ashburn, VA (US); Siddhartha Chenumolu, Ashburn, VA (US)

(21) Appl. No.: 18/634,697

(22) Filed: Apr. 12, 2024

Related U.S. Application Data
(60) Provisional application No. 63/562,530, filed on Mar. 7, 2024.

(51) Int. Cl. H04W 52/02; H04W 24/02

(52) U.S. Cl. CPC H04W 52/0206; H04W 24/02

(57) ABSTRACT

Systems and methods for dynamically modifying power consumption of cells in a cellular network. Historical network performance and topology information regarding the cellular network is obtained. The historical information is used to generate at least one network energy saving model of the network. Current network performance and topology information is then obtained regarding the cellular network. The at least one network energy saving model is employed on the current network performance and topology information to set an energy saving configuration for at least one cell in the network. The energy saving configuration is then used to reduce energy utilized by the at least one cell.

### BACKGROUND

The use of cellular networks continues to expand, and people are becoming more reliant on the speed, efficiency, and uptime of these networks. But companies are continuously balancing the expansion of cellular network and the needs of users with business considerations and costs. It is with respect to these and other considerations that the embodiments described herein have been made.

### BRIEF SUMMARY

Briefly, embodiments are directed to systems and methods for dynamically modifying power consumption of cells in a cellular network. Historical network performance and topology information regarding the cellular network is obtained. The historical information is used to generate at least one network energy saving model of the network. Current network performance and topology information is then obtained regarding the cellular network. The at least one network energy saving model is employed on the current network performance and topology information to set an energy saving configuration for at least one cell in the network. The energy saving configuration may identify a cell that is to be put into a full energy saving mode (e.g., power down the cell) or a partial energy saving mode (e.g., utilize reduced transmit power) or a no energy saving mode (e.g., if the cell is a primary cell that is not to enter an energy saving mode. The energy saving configuration is then used to reduce energy utilized by the at least one cell.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings:

FIG. 1 illustrates a context diagram of an environment for employing energy saving strategies across a cellular network in accordance with embodiments described herein;

FIG. 2 is a context diagram of a non-limiting example illustration of systems that provide functionality to generate and employ energy saving strategies across a cellular network in accordance with embodiments described herein;

FIG. 3 illustrates a logical flow diagram showing one embodiment of a process for generating and employing network energy saving strategies in accordance with embodiments described herein;

FIGS. 4A-4C illustrate a logical flow diagram showing one embodiment of a process for generating or setting configuration information for cells within a cellular network to save energy across the cellular network in accordance with embodiments described herein;

FIG. 5 illustrates a logical flow diagram showing one embodiment of a process for utilizing or employing the configuration information for cells within the cellular network to save energy in accordance with embodiments described herein; and

FIG. 6 shows a system diagram that describes one implementation of computing systems for implementing embodiments described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

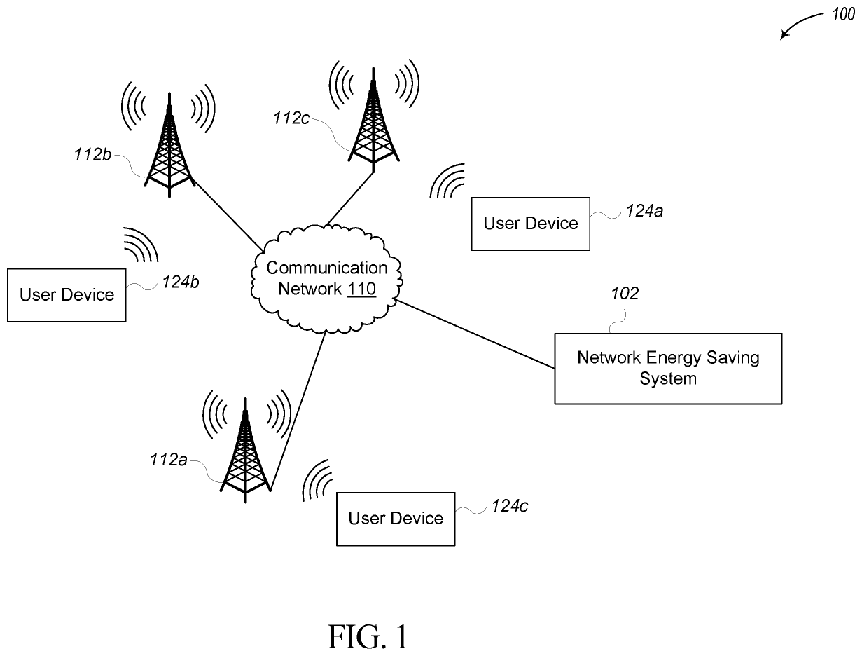

FIG. 1 illustrates a context diagram of an environment for employing energy saving strategies across a cellular network in accordance with embodiments described herein. Environment 100 includes a plurality of cells 112a-112c, a plurality of user devices 124a-124c, and network energy saving system 102, which may be in communication via a communication network 110. Communication network 110 includes one or more wired or wireless networks. Collectively, communication network 110 and cells 112a-112c may be referred to as a cellular communication network, such as a 5G cellular network.

The user devices 124a-124c are computing devices that are configured to communicate with the cellular network via cells 112a-112c. In various embodiments, user devices 124a-124c receive and transmit cellular communication messages or data with the cells 112a-112c. Examples of user devices 124a-124c may include, but are not limited to, mobile devices, smartphones, tablets, cellular-enabled laptop computers, or other computing devices that can communication with a cellular network. The user devices 124a-124c may be individually referred to as a user device 124 or collectively referred to as user devices 124. User devices 124a-124c may also be referred to as user equipment. Although FIG. 1 shows three user devices 124a-124c, embodiments are not so limited. Rather, one user device or a plurality of user devices may be in communication with the network.

The cells 112a-112c are cellular towers that together provide the hardware infrastructure of the cellular network. The cells 112a-112c may be individually referred to as a cell 112 or collectively referred to as cells 112. The cells 112a-112c may include or be in communication with base stations, radio back haul equipment, antennas, or other devices, which are not illustrated for ease of discussion. Although FIG. 1 shows three cells 112a-112c, embodiments are not so limited. Rather, a plurality of cells may be employed.

Cells 112a-112c provide compatible cellular communications over a coverage area, which may be referred to as a sector. In various embodiments, a plurality of cells 112 may provide coverage over a same sector. The coverage area of each terrestrial network cell 112 may vary depending on the elevation antenna of the cell, the height of the antenna of the cell above the ground, the electrical tilt of the antenna, the transmit energy utilized by the cell, or other capabilities that can be different from one type of cell to another or from one type of hardware to another. The overall capacity of the network created by the cells 112a-112c depends on the coverage of each cell and the interference that the cells may have on each other.

In various embodiments, a group of cells 112a-112c that make up the cellular communication network may be referred to as a “market.” A market may be for a particular city, neighborhood, geographical area, or other selected or specified cluster of cells.

The network energy saving system 102 is configured to perform embodiments described herein to generate and employ one or more network energy saving models to determine when cells 112a-112c can be put into a full energy saving mode, a partial energy saving mode, or prevented from entering an energy saving mode, as described herein. The network energy saving system 102 can then instruct the cells 112a-112c, or their corresponding components, to enter the determined energy saving mode, as described herein.

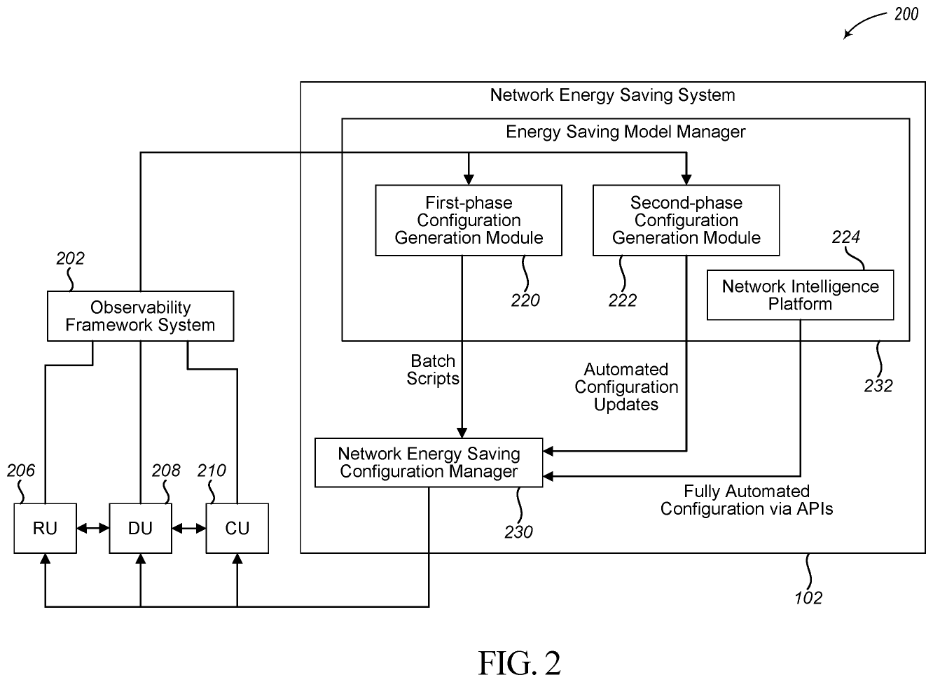

FIG. 2 is a context diagram of a non-limiting example illustration of systems that provide functionality to generate and employ energy saving strategies across a cellular network in accordance with embodiments described herein. Environment 200 may be similar to that which is shown in FIG. 1, but environment 200 includes network energy saving system 102, observability framework 202, radio units (RUs) 206, distributed units (DUs) 208, and central units (CUs) 210. Collectively, the RUs 206, DUs 208, and CUs 210 provide network functions of cells 112a-112c. Although not illustrated, other network functions may also be utilized.

The RUs 206 are configured to provide the antenna and radio functions for a cell to communication with user devices. The DUs 208 provide real-time support for lower layers of the protocol stack for cellular communications, such as the radio link control (RLC) layer and the medium access control (MAC) layer. The CUs 210 may provide support for higher layers of the protocol stack for cellular communications, such as the service data adaptation protocol (SDAP) layer, the packet data convergence control (PDCP) layer, and the radio resource control (RRC) layer. In some embodiments, the DUs 208 and the CUs 210 may be executed as virtual instances within a data center environment. Collectively, the RUs 206, the DUs 208, and the CUs 210 provide the structural aspects for the cells of the network to facilitate communications between user devices and the network.

The observability framework system 202 is configured to monitor the RUs 206, the DUs 208, and the CUs 210 to gather current and historical network performance and topology information regarding the cellular network. Briefly, this information indicates how cells have performed in the past or are currently performing, the location or topology of cells (e.g., which cells are in a same sector or cover a same or similar geographic area), information regarding numbers or types of user devices communicating via the cells, how user devices are utilizing the cells (e.g., physical resource blocks are being utilized for uplink or downlink transmissions), performance or fault or heath metrics of the cells (e.g., quality of service metrics, number of failed or dropped connections, data throughput, etc.), traffic models for unique users utilizing the cells, service level assurances to user devices at particular times or days, priority of the cells, whether a cell has been tagged as a primary cell (e.g., a cell that cannot enter an energy saving mode), whether a cell has been tagged for full energy saving mode or partial energy saving mode, energy being consumed by components associated with cells, etc. or some combination thereof. Although the observability framework system 202 is illustrated as being separate from the network energy saving system 102, embodiments are not so limited. In some embodiments, the functionality of the observability framework system 202 may be performed by the network energy saving system 102.

The network energy saving system 102 includes an energy saving model manager 232 and a network energy saving configuration manager 230. The energy saving model manager 232 is configured to support the generation and utilization of one or more network energy saving models. In some embodiments, the energy saving model manager 232 includes a first-phase configuration generation module 220, a second-phase configuration generation module 222, and network intelligence platform 224.

The first-phase configuration generation module 220 may be configured receive current or historical network performance and topology information regarding the cellular network from the observability framework system 202. The first-phase configuration generation module 220 can utilize manual or semi-automated mechanisms to generate one or more network energy saving models from this historical information. For example, vendor features, manually generated scripts, or initial artificial intelligence mechanisms may be used to generate the one or more network energy saving models based on the historical information. The first-phase configuration generation module 220 can then utilize the current network performance and topology information regarding the cellular network and the network energy saving models to generate or set energy saving configurations for one or more cells supported by the RUs 206, the DUs 208, and the CUs 210. In at least one embodiment, the first-phase configuration generation module 220 can provide these energy saving configurations to the network energy saving configuration manager 230 as batch scripts.

The second-stage configuration generation module 222 may also be configured receive current or historical network performance and topology information regarding the cellular network from the observability framework system 202. The second-phase configuration generation module 222 can utilize standalone artificial intelligence mechanism or machine learning mechanisms to generate one or more network energy saving models. In at least one embodiment, this standalone artificial intelligence mechanism may be trained using results or feedback from the models generated and employed by the first-phase configuration generation module 220. The second-phase configuration generation module 222 can then utilize the current network performance and topology information regarding the cellular network and the network energy saving models to generate or set energy saving configurations for one or more cells supported by the RUs 206, the DUs 208, and the CUs 210. In at least one embodiment, the second-phase configuration generation module 222 can provide these energy saving configurations to the network energy saving configuration manager 230 as automated configuration updates.

The network intelligence platform 224 may be configured as a fully automated selection and utilization of energy saving configurations. In various embodiments, the network intelligence platform 224 can utilize pre-defined APIs with the network energy saving configuration manager 230 to adjust energy saving configuration settings for various network functions of cells supported by the RUs 206, the DUs 208, and the CUs 210.

Although FIG. 2 illustrates a single energy saving model manager 232, embodiments are not so limited, and a plurality of energy saving model managers 232 may be employed. In some embodiments, a separate energy saving model managers 232 may be employed for each separate network function of the cellular network. In other embodiments, a separate energy saving model manager 232 may be employed for each separate market of the cellular network.

The network energy saving configuration manager 230 is configured to receive the energy saving configurations for one or more cells from the energy saving model manager 232. The network energy saving configuration manager 230 is also configured to utilize those energy saving configurations to power off or reduce power consumption of one or more cells, as described herein. Although FIG. 2 illustrates a single network energy saving configuration manager 230, embodiments are not so limited, and a plurality of network energy saving configuration managers 230 may be employed. In some embodiments, a separate network energy saving configuration manager 230 may be employed for each separate network function of the cellular network. In other embodiments, a separate network energy saving configuration manager 230 may be employed for each separate market of the cellular network.

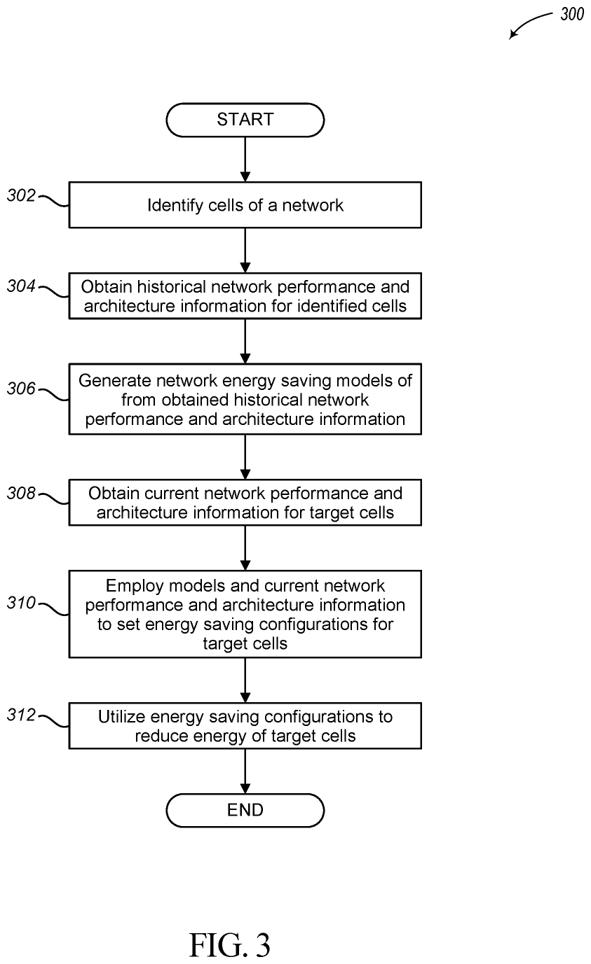

The operation of certain aspects will now be described with respect to FIGS. 3, 4A-4C, and 5. In at least one of various embodiments, processes 300, 400, and 500 described in conjunction with FIGS. 3, 4A-4C, and 5, respectively, may be implemented by or executed via circuitry or on one or more computing devices, such as network energy saving system 102 in FIG. 1.

FIG. 3 illustrates a logical flow diagram showing one embodiment of a process 300 for generating and employing network energy saving strategies in accordance with embodiments described herein.

Process 300 begins, after a start block, at block 302, where one or more cells of a network are identified. In some embodiments, the cells of a particular market or geographical area are identified or otherwise selected. In other embodiments, non-primary cells, e.g., cells that cannot be powered down or put into an energy saving mode, may be identified.

Process 300 proceeds after block 302 to block 304, where historical network performance and topology information are obtained. In various embodiments, this historical information indicates how the identified cells have performed in the past, the location or topology of the identified cells (e.g., which cells are in a same sector or cover a same or similar geographic area), information regarding numbers or types of user devices communicating via the identified cells, how user devices are utilizing the identified cells (e.g., physical resource blocks are being utilized for uplink or downlink transmissions), performance or fault or heath metrics of the identified cells (e.g., quality of service metrics, number of failed or dropped connections, data throughput, etc.), traffic models for unique users utilizing the identified cells, service level assurances to user devices at particular times or days, priority of the identified cells, whether an identified cell has been tagged as a primary cell (e.g., a cell that cannot enter an energy saving mode), whether an identified cell has been tagged for full energy saving mode or partial energy saving mode, energy being consumed by components associated with the identified cells, etc. or some combination thereof.

Process 300 continues after block 304 at block 306, where one or more network energy saving models is generated from the obtained historical network performance and topology information. In various embodiments, the one or more network energy saving models define or identify which energy saving configuration to employ for which cells given the current conditions of the network. In some embodiments, at least one of the network energy saving models may be utilized to predict the load on one or more cells based on the current day or time, or topography of the network.

In some embodiments, one or more artificial mechanism is employed to train the at least one network energy saving model from the historical network performance and topology information. In other embodiments, an administrator may manually define the at least one network energy saving model from the historical network information. In some other embodiments, vendor-generated functions may be used to define the at least one network energy saving model from the historical network information.

In various embodiments, a plurality of network energy saving models may be generated. In some embodiments, separate network energy saving models may be generated for separate network functions. For example, a first network energy saving model may be used to determine when radio units of the identified cells are to be put into an energy saving mode, and a second network energy saving model may be used to determine how distributed units associated with the identified cells are put into an energy saving mode, etc. In other embodiments, separate network energy saving models may be generated for separate markets, neighborhoods, or geographical areas. For example, a first network energy saving model may be used to determine when cells in a metropolitan market are to be put into an energy saving mode, and a second network energy saving model may be used to determine when cells in a rural market are to be put into an energy saving mode.

Process 300 proceeds after block 306 to block 308, where current network performance and topology information is received for one or more target cells. In some embodiments, the target cells may be the same cells as, or a subset (but not all) of the cells, identified in block 302. In other embodiments, the target cells may be separate from the cells identified at block 302, but share some characteristic as the identified cells. For example, the identified cells may have been in a first metropolitan market and the target cells may be for a second metropolitan market.

In some embodiments, a multi-phase approach may be used to generate the one or more network energy saving models. In a first phase, manual or semi-automated mechanisms may be utilized to generate the one or more models. For example, vendor features, manually generated scripts, or initial artificial intelligence mechanisms may be used to generate the one or more network energy saving models. In a second phase, a standalone artificial intelligence mechanism may be used to generate the one or more network energy saving models. In at least one embodiment, this standalone artificial intelligence mechanism may be trained using results or feedback from the models generated and employed during the first phase. In a third phase, a network intelligence platform may be used to fully automate the selection and utilization of energy saving configurations. In various embodiments, the network intelligence platform can utilize pre-defined APIs to adjust energy saving configuration settings for various network functions of target cells.

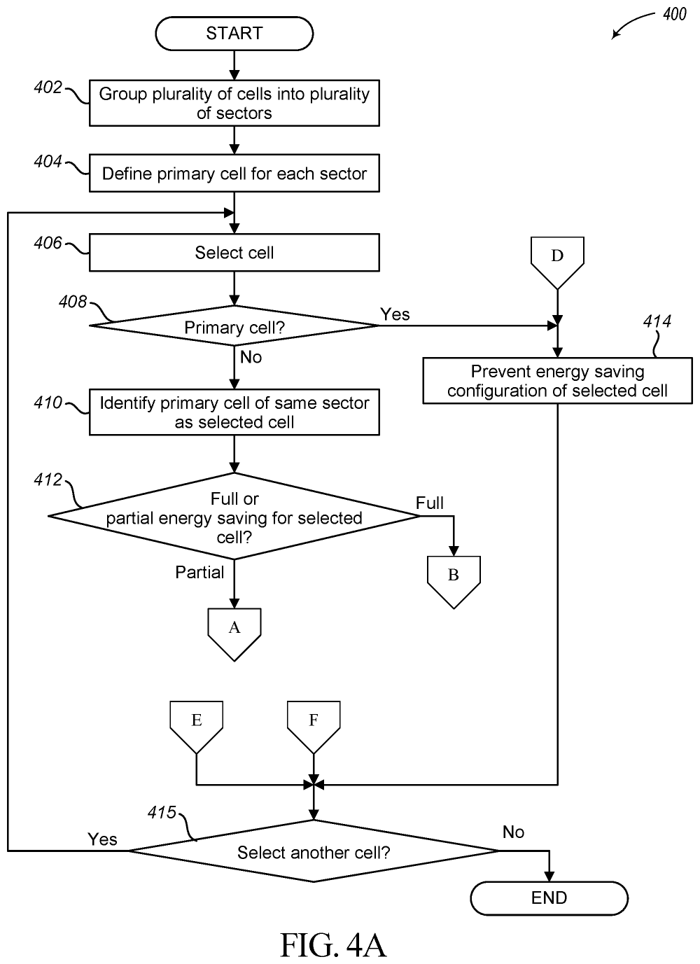

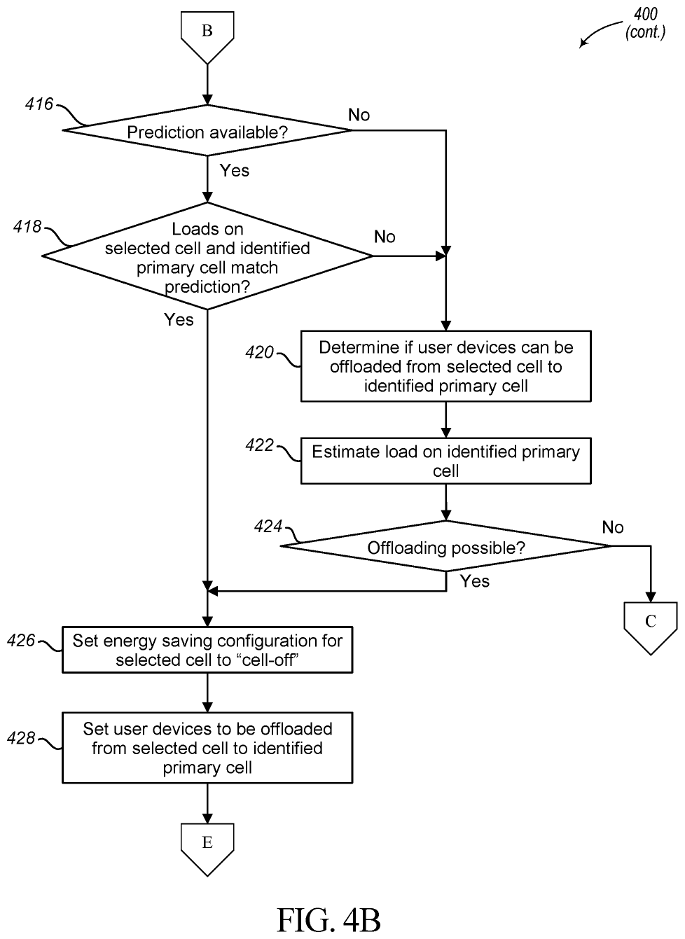

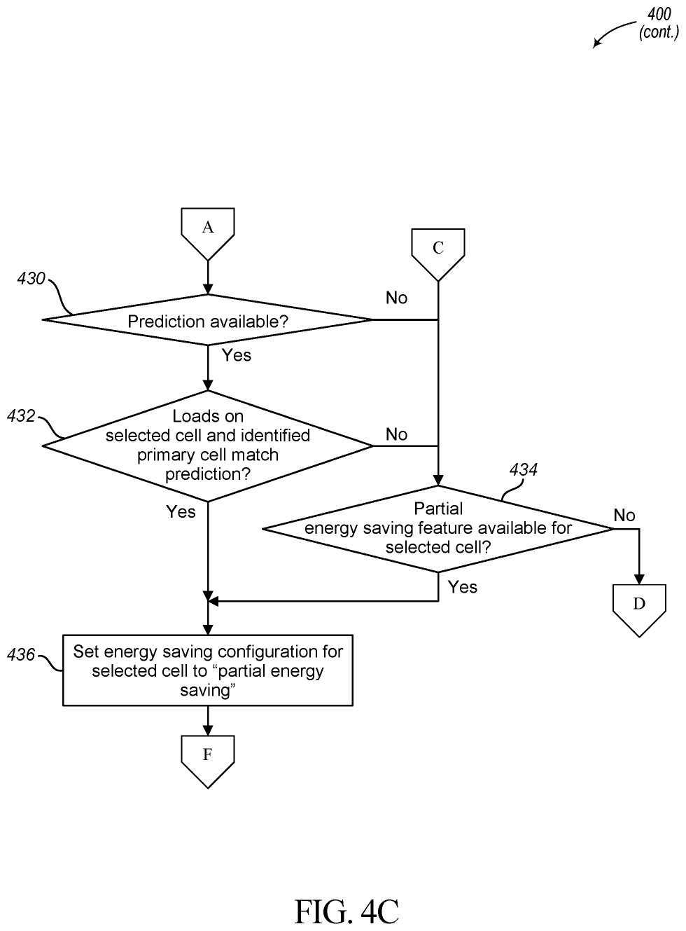

Process 300 continues after block 308 at block 310, where the one or more models generated at block 306 are employed along with the current network performance and topology information to set one or more energy saving configurations for the target cells. In at least one embodiment, process 400 described in conjunction with FIGS. 4A-4C may be performed to set the energy saving configurations for the target cells.

In various embodiments, the energy saving configurations for one or more target cells may also be set or modified based on other network or user experience criteria. In some embodiments, one or more user Quality of Experience (QoE) thresholds may be utilized to determine if a target cell can be put into an energy saving mode. For example, assume a user device connected to a target cell, or a sector covered by the target cell, has a minimum QoE threshold. If putting that target cell into an energy saving mode (e.g., a partial or full energy saving mode) would result, or potentially result, in the network's failure to meet that QoE threshold, then that target cell would not be put into an energy saving mode. In various embodiments, the Quality of Experience (QoE) threshold may be a minimum quality of service, a minimum throughput, a minimum latency, other network connection capabilities or capacities, or some combination thereof.

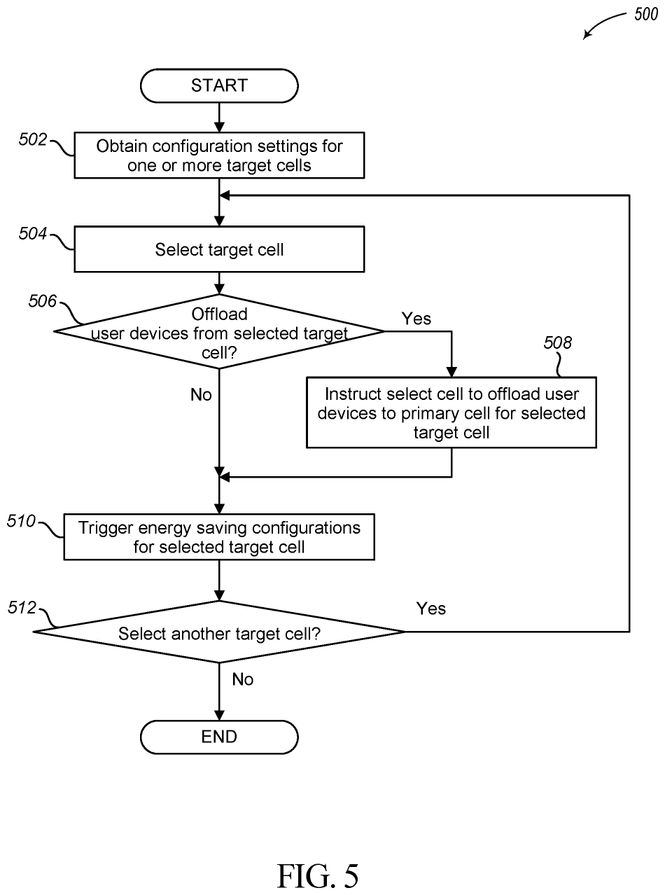

Process 300 proceeds after block 310, to block 312, where the energy saving configurations are utilized to reduce energy associated with the target cells. In at least one embodiment, process 500 described in conjunction with FIG. 5 may be performed to reduce the energy associated with the target cells based on the energy saving configurations for those target cells.

After block 312, process 300 terminates or otherwise returns to a calling process to perform other actions. In some embodiments, process 300 may loop (not illustrated) from block 312 to block 308 to obtain new current network performance and topology information for the same or separate target cells. In this way, the network can be continuously monitored to dynamically reduce the total amount of energy being utilized by cells in the network as needed, while maintaining accessibility and efficiency of the network.

Although not illustrated, the one or more models generated at block 306 may also indicate when the energy saving configurations for target cells should be reversed. For example, when the user device traffic of a primary cell increases to satisfy a threshold amount, then the energy saving configurations of other cells can be reversed and those cells can be powered back on, or restored to a full energy mode, to help support the network.

FIGS. 4A-4C illustrate a logical flow diagram showing one embodiment of a process 400 for generating or setting configuration information for cells within a cellular network to save energy across the cellular network in accordance with embodiments described herein. In various embodiments, process 400, or parts of process 400, may be performed at selected times or intervals such that the energy saving configurations of cells in the network can dynamically change over time as load on the network changes. In at least one embodiment, process 400 may be performed by energy saving model manager 232 in FIG. 2.

Process 400 begins, after a start block in FIG. 4A, at block 402, where a plurality of cells are grouped into a plurality of sectors. A sector is a geographical area in which one or more cells provide access to a cellular network. Each cell provides a defined frequency spectrum for a specific sector. In this way, a plurality of cells provide access to a given sector. The cells of a given sector may be provided by a single cellular tower or cell site, or they may be provided by multiple cellular towers or cell sites (e.g., when there is an overlap in coverage areas by separate cellular towers or cell sites).

Process 400 proceeds after block 402 to block 404, where one or more primary cells are defined for each sector. A primary cell is a cell that cannot enter an energy saving mode, as described herein. In this way, the network maintains a minimal level of availability to user devices. In other embodiments, the primary cell may be referred to as a primary carrier, primary service, or primary service carrier.

In some embodiments, a single cell may be defined as a primary cell for a sector. For example, in some embodiments, the primary cell of a given sector may be a cell utilizing a low-band frequency spectrum. In other embodiments, the primary cell of a given sector may be a cell utilizing a mid-band frequency spectrum with low channel bandwidth. In yet other embodiments, the primary cell of a given sector may be a cell utilizing a mid-band frequency spectrum with higher channel bandwidth. The frequency spectrum used by primary cells may be the same or different for separate sectors.

In other embodiments, a plurality of cells, or a set of cells, in a sector may be defined as a primary cell for that sector. Accordingly, the primary cell may be the grouping or combination of multiple cells. For example, the primary cell may be a combination of a cell utilizing low-band frequency spectrum and a cell utilizing a mid-band frequency spectrum with low channel bandwidth.

In some other embodiments, the primary cell for a sector may be set or defined from a plurality of primary cell criteria. In one non-limiting example, the primary cell criteria may include a first criteria of low-band frequency spectrum, a second criteria of mid-band frequency spectrum with low channel bandwidth, and a third criteria of mid-band frequency spectrum with higher channel bandwidth. The primary cell can then be set from any combination of one, two, or three of these primary cell criteria depending on the current load on cells of that sector. In this way, a group of one or more primary cell criteria may be used to define a primary cell for a sector. For example, in certain scenarios, a single primary cell criteria may not be able to support the load from all the other cells in that sector. Therefore, embodiments described herein have the flexibility of modifying how the primary cell is set for a sector. In one non-limiting illustrative example, one cell, which may be initially defined or labeled as a primary cell, may be utilizing only 5 MHz, which may be insufficient to handle all the load from the other cells in the sector. Accordingly, another 5 MHz from the remaining cells in the sector may be added to the primary cell.

In some embodiments, an administrator may define which cells are primary cells for a given sector. In other embodiments, primary cells may be identified through an artificial intelligence learning mechanism, such as via the training or learning of the network energy saving models generated at block 306 in FIG. 3.

In some other embodiments, one or more cells in sector may be labeled or identified as a primary cell to ensure that the network maintains a minimum QoE threshold. As discussed above, the network may have one or more QoE thresholds to ensure a minimum level of end user experience while a user is using the network. By labeling one or more cells as a primary cell to maintain minimum QoE thresholds, those cells do not enter an energy saving mode, which ensures that utilization of energy saving configurations described herein don't impact the end user experience.

Process 400 continues after block 404 at block 406, where a cell is selected from the plurality of cells. In various embodiments, each cell of the plurality of cells may be selected in an orderly manner such that each cell is selected and processed via process 400.

Process 400 proceeds after block 406 to decision block 408, where a determination is made whether the selected cell is a primary cell or not. If the selected cell is a primary cell, then process 400 flows from decision block 408 to block 414 where the selected cell is prevented from utilizing a energy saving configuration. But it the selected cell is not a primary cell, then process 400 flows from decision block 408 to block 410.

At block 410, a primary cell of the same sector as the selected cell is identified. In some embodiments, a database may be maintained, which identified the plurality of sectors, which cells are grouped into each corresponding sector, and which of those cells is the primary cell for the corresponding sector.

Process 400 proceeds after block 410 to decision block 412, where a determination is made whether the selected cell is available for full energy saving mode or for partial energy saving mode. In some embodiments, the selected cell may be tagged with the energy saving mode that is available to that cell. As discussed herein, some cells may be tagged as being available for full energy saving mode because all components of those cells may be configurable to turn off or power down. And other cells may be tagged as being available for partial energy saving mode because some components of those calls can take advantage of some energy reduction features, but cannot fully turn off or powered down.

In some embodiments, the distinction between a cell having full energy saving mode or partial energy saving mode may be determined by an administrator. In other embodiments, the distinction between a cell having full energy saving mode or partial energy saving mode may be determined by the hardware components, location, or arrangement of hardware components of a cell.

If the selected cell has the full energy saving mode available, then process 400 flows from decision block 412 in FIG. 4A to decision block 416 in FIG. 4B. If the selected cell has the partial energy saving mode available, then process 400 flows from decision block 412 in FIG. 4A to decision block 430 in FIG. 4C.

At decision block 416 in FIG. 4B, a determination is made whether a load prediction is available for the selected cell. In some embodiments, a load prediction may be available where a network energy saving model is generated to predict the load on the selected cell for the current day or time, or topography of the network. If a load prediction is available, process 400 flows to decision block 418; otherwise, process 400 flows to block 420.

At decision block 418, a determination is made whether a current load on the selected cell and a current load on the identified primary cell match the prediction. In some embodiments this determination is based on whether the current loads on the selected cell and the identified primary cell are below a predicted threshold for those cells. For example, the prediction may be that the current load on the selected cell is below a first threshold indicating that there is very little traffic on the selected cell, and the current load on the identified primary cell is below a second threshold indicating that the identified primary cell has capacity to increase its traffic load. If the current load on the selected cell and the current load on the identified primary cell match the prediction, then process 400 flows to block 426; otherwise, process 400 flows to block 420.

At block 420, a determination is made whether user devices can be offloaded from the selected cell to the identified primary cell. In various embodiments, user devices can be offloaded from the selected cell to the identified primary cell if the user device is within range of the identified primary cell, if the user device supports the frequency spectrum being utilized by the identified primary cell, if the identified primary cell can provide the service level assurance for the user device, etc. In some embodiments, the system may be prohibited from offloading some user devices, such as if the quality of service provided to a user device is predicted to be below a threshold value after the offload, or if the user device is engaged in an emergency call and offloading may risk dropping that call. In some embodiments, an estimate of the amount or type of traffic that may be offloaded from the selected cell to the identified primary cell may be determined.

Process 400 proceeds after block 420 to block 422, where an estimated load on the identified primary cell is determined based on whether user devices can be offloaded to from the selected cell to the identified primary cell. The estimated load may be based on a combination of the current load of the selected cell and the current load of the identified primary cell. In other embodiments, the estimated load may be based on a combination of the current load of the identified primary cell and the current load of all other cells in the same sector. Because multiple cells in a sector may be put into an energy saving mode, user devices may be offloaded from multiple cells to the primary cell of that sector. The estimated load of the primary cell is to determine if the primary cell can support or handle all, or some, of the user devices that are to be offloaded from the cells in that sector.

In some embodiments, the determinations and estimates determined at blocks 420 and 422 may be stored in a database for future load predictions and to determine how the network energy saving models are performing under different network conditions. For example, in some embodiments, each cell's predicted load may be stored to a database. Also, the predicted load (prior to utilization or employing the energy saving configurations) on one or more primary cells may be stored in the database for a plurality of different loading or user conditions. These stored predictions can be compared to the actual loading on primary cells after the utilization or employment of the energy saving configurations to determine how accurate the models were at generating the predicted loads. In various embodiments, the actual loads, along with the predicted loads, may be used as feedback for model drift detection and to re-train the models.

Process 400 continues after block 422 at decision block 424, where a determination is made whether offloading is possible from the selected cell to the identified primary cell. In various embodiments, offloading is possible when user devices can be offloaded from the selected cell to the identified primary cell and the estimated load on the primary cell does not exceed a selected threshold. In some situations, user devices from a first cell (e.g., a previously selected cell when performing process 400) in a sector may be offloaded to the primary cell in that sector but user devices from a second cell (e.g., a currently selected cell when performing process 400) in that sector may not be offloaded so as to not overload the primary cell. If offloading is possible, process 400 flows from decision block 424 to block 426; otherwise, process 400 flows from decision block 424 to decision block 434 in FIG. 4C.

If, at decision block 418 in FIG. 4B, the loads on the selected cell and the identified primary cell match the prediction or if, at decision block 424 in FIG. 4B, offloading is possible, process 400 continues at block 426. At block 426, the energy saving configuration for the selected cell is set to “cell-off” or “power down,” or set to be put into or enter a full energy saving mode.

Process 400 proceeds after block 426 to block 428, where the user devices connected to the selected sell are set to be offloaded to the identified primary cell.

After block 428, process 400 continues to decision block 415 in FIG. 4A to determine if another cell is to be selected and processed to determine if that other selected cell is to enter an energy saving mode.

If, at decision block 412 in FIG. 4A, a determination is made that the partial energy saving mode is available to the currently selected cell, then process 400 flows from decision block 412 in FIG. 4A to decision block 430 in FIG. 4C.

At decision block 430, a determination is made whether a load prediction is available for the selected cell. In various embodiments, decision block 430 may employ embodiments of decision block 416 to determine if a load prediction is available. If a load prediction is available, process 400 flows to decision block 432; otherwise, process 400 flows to decision block 434.

At decision block 432, a determination is made whether a current load on the selected cell and a current load on the identified primary cell match the prediction. In various embodiments, decision block 432 may employ embodiments of decision block 418 to determine if the loads match the prediction. If the current load on the selected cell and the current load on the identified primary cell match the prediction, then process 400 flows to block 436; otherwise, process 400 flows to decision block 434.

At block 434, a determination is made whether there are partial energy saving features available for the selected cell. In various embodiments, the partial energy saving features may include reducing transmit energy or power of a power amplifier of a radio unit associated with the selected cell, powering down at least one transmit antenna (but not all antenna) associated with the selected cell, reducing the number of DUs or CUs available to the selected cell, or otherwise reducing energy or power being consumed by one or more components of the selected cell. If the selected cell has at least one partial energy saving feature available, then process 400 flows from decision block 434 in FIG. 4C to block 436; otherwise, process 400 flows from decision block 434 in FIG. 4C to block 414 in FIG. 4A to prevent energy saving configuration of the selected cell.

At block 436, the energy saving configuration for the selected cell is set to “partial energy saving,” or set to be put into or enter a partial energy saving mode. After block 436, process 400 continues to decision block 415 in FIG. 4A to determine if another cell is to be selected and processed to determine if that other selected cell is to enter an energy saving mode. If additional cells are to be selected, then process 400 loops from decision block 415 in FIG. 4A to block 406; otherwise, process 400 terminates or otherwise returns to a calling process to perform other actions.

As noted above, process 400, or parts of process 400, may be performed at selected times or intervals such that the energy saving configurations of cells in the network can dynamically change over time as load on the network changes.

After energy saving configurations of cells is determined via process 400, process 500 in FIG. 5 may be implemented to utilize the configurations to power down or reduce the energy consumption of components associated with various cells in the network.

FIG. 5 illustrates a logical flow diagram showing one embodiment of a process 500 for utilizing or employing the configuration information for cells within the cellular network to save energy in accordance with embodiments described herein. In at least one embodiment, process 500 may be performed by network energy saving configuration manager 230 in FIG. 2.

Process 500 begins, after a start block, at block 502, where configuration settings are obtained for one or more cells in a network. In various embodiments, the configuration settings are the energy saving configurations set at block 428 in FIG. 4B or block 436 in FIG. 4C. In some embodiments, the configuration settings may be obtained for a single target cell in the network. In other embodiments, the configuration settings may be obtained for a plurality of target cells in the network.

Process 500 proceeds after block 502 to block 504, where a target cell is selected. In various embodiments, each target cell in which configuration settings are obtained are selected in an orderly manner such that each target cell is selected and processed.

Process 500 continues after block 504 at decision block 506, where a determination is made whether user devices are to be offloaded from the selected target cell. When the energy saving configuration of the selected target cell is set to “cell-off,” or the selected target cell is set to be put into or enter a full energy saving mode, then user devices currently connected to the selected target cell are offloaded to the primary cell in the same sector as the selected target cell. If user devices are to be offloaded from the selected target cell, then process 500 flows to block 508; otherwise, process 500 flows to block 510.

At block 508, the selected target cell is instructed to offload user devices connected to the selected target cell to the primary cell for the selected target cell. In response to receiving the instruction to offload user devices, the selected target cell can implement one or more handovers or other techniques to offload the connections from the selected target cell to the primary cell.

After block 508, or if, at decision block 506, there are no user devices to offload from the selected target cell, then process 500 continues at block 510. At block 510, the energy saving configurations for the selected target cell are triggered. If the configuration settings for the selected target cell are to put the cell into a full energy saving mode, then all components associated with the selected target cell may be instructed to turn off or power down. For example, the radio unit, DUs, CUs, or other components of the selected target cell are powered off or otherwise powered down to save energy. If the configuration settings for the selected target cell are to put the cell into a partial energy saving mode, then one or more components associated with the selected target cell may be instructed to turn off or use less energy, but not fully turn off the selected target cell. For example, the radio unit associated with the selected target cell may be instructed to use a lower transmit power. Other reduced energy or reduced power features of the selected target cell may also be instructed or implemented by the selected target cell.

Process 500 proceeds after block 510 to decision block 512, where a determination is made whether another target cell is selected. In various embodiments, each of a plurality of target cells are selected such that they can be put into a full or partial energy saving mode. If another target cell is to be selected, process 500 loops to block 504; otherwise, process 500 terminates or otherwise returns to a calling process to perform other actions.

As noted above, energy saving configurations may be set via process 400 in FIG. 4 at selected times or intervals. Accordingly, process 500 may also be performed at selected times or intervals, or in response to process 400, such that the energy saving configurations of cells in the network can dynamically change over time as load on the network changes.

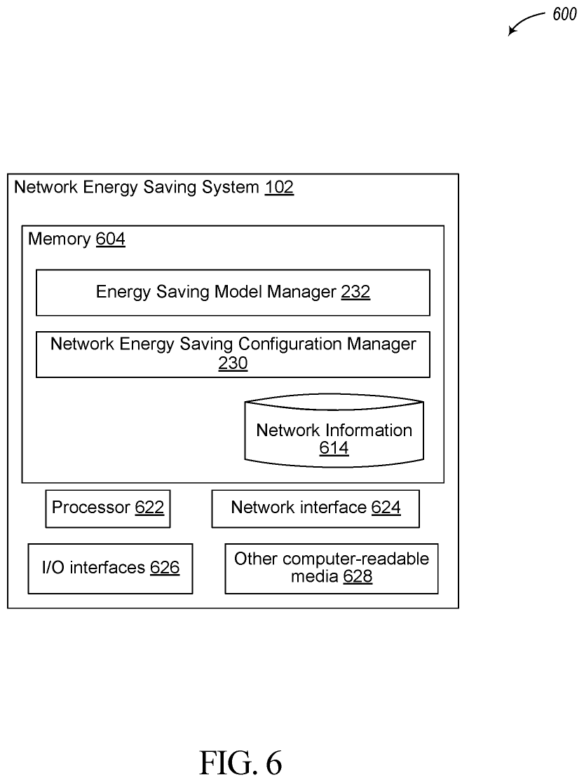

FIG. 6 shows a system diagram that describes one implementation of computing systems 600 for implementing embodiments described herein. System 600 includes network energy saving system 102. Although not illustrated, system 600 also includes cells 112a-112c, user devices 124a-124c, and other network aspects similar to what is described herein.

As described herein, the network energy saving system 102 is a computing device or system that can perform functionality described herein for generating and utilizing network energy saving models to set energy saving configurations for cells in a network. One or more special purpose computing systems may be used to implement the network energy saving system 102. Accordingly, various embodiments described herein may be implemented in specialized software, hardware, firmware, or in some combination thereof. The network energy saving system 102 includes memory 604, processor 622, network interface 624, input/output (I/O) interfaces 626, and other computer-readable media 628.

Processor 622 includes one or more processors, one or more processing units, programmable logic, circuitry, or one or more other computing components that are configured to perform embodiments described herein or to execute computer instructions to perform embodiments described herein. In some embodiments, a processor system of the network energy saving system 102 may include a single processor 622 that operates individually to perform actions. In other embodiments, a processor system of the network energy saving system 102 may include a plurality of processors 622 that operate to collectively perform actions, such that one or more processors 622 may operate to perform some, but not all, of such actions. Reference herein to “a processor system” of the network energy saving system 102 refers to one or more processors 622 that individually or collectively perform actions. And reference herein to “the processor system” of the network energy saving system 102 refers to 1) a subset or all of the one or more processors 622 comprised by “a processor system” of the network energy saving system 102 and 2) any combination of the one or more processors 622 comprised by “a processor system” of the network energy saving system 102 and one or more other processors 622.

Memory 604 may include one or more various types of non-volatile or volatile storage technologies. Examples of memory 604 include, but are not limited to, flash memory, hard disk drives, optical drives, solid-state drives, various types of random-access memory (“RAM”), various types of read-only memory (“ROM”), other computer-readable storage media (also referred to as processor-readable storage media), or other memory technologies, or any combination thereof. Memory 604 may be utilized to store information, including computer-readable instructions that are utilized by a processor system of one or more processors 622 to perform actions, including at least some embodiments described herein.

Memory 604 may have stored thereon energy saving model manager 232 and network energy saving configuration manager 230. The energy saving model manager 232 is configured to generate and utilize network energy saving models, as described herein. And the network energy saving configuration manager 230 is configured to utilize energy saving configurations generated by the energy saving model manager 232 to instruct cells to modify their energy consumption, such as by entering a full energy saving mode or a partial energy saving model, as described herein.

Memory 604 may also store network information 614, such as historical or current network performance and topology information regarding the cellular network.

Network interface 624 is configured to communicate with other computing devices, such as to instruct cells 112a-112c to modify energy consumption. I/O interfaces 626 may include interfaces for various input or output devices, such as USB interfaces, physical buttons, keyboards, haptic interfaces, tactile interfaces, or the like. Other computer-readable media 628 may include other types of stationary or removable computer-readable media, such as removable flash drives, external hard drives, or the like.

The following is a summarization of the claims as originally filed.

A method may be summarized as comprising: identifying at least one cell of a cellular network; obtaining historical network performance and topology information regarding the cellular network; generating at least one network energy saving model from the historical network performance and topology information; obtaining current network performance and topology information regarding the cellular network; employing the at least one network energy saving model on the current network performance and topology information to set an energy saving configuration for the at least one cell; and utilizing the energy saving configuration to reduce energy utilized by the at least one cell.

The method may employ the at least one network energy saving model on the current network performance and topology information to set the energy saving configuration for the at least one cell by: determining if offloading of user devices from the at least one cell to a primary cell is possible; and in response to determining that offloading of user devices from the at least one cell to the primary cell is possible: setting the energy saving configuration for the at least one cell to power down; and labeling the user devices for offloading from the at least one cell to the primary cell.

The method may employ the at least one network energy saving model on the current network performance and topology information to set the energy saving configuration for the at least one cell by: determining if a first current load on the at least one cell and a second current load on a primary cell associated with the selected cell match a predicted amount of load; and in response to determining that the first current load on the at least one cell and the second current load on the primary cell associated with the selected cell match the predicted amount of load: setting the energy saving configuration for the at least one cell to power down; and labeling the user devices for offloading from the at least one cell to the primary cell.

The method may employ the at least one network energy saving model on the current network performance and topology information to set the energy saving configuration for the at least one cell by: determining that the at least one cell is labeled for full energy savings; and setting the energy saving configuration for the at least one cell to power down.

The method may employ the at least one network energy saving model on the current network performance and topology information to set the energy saving configuration for the at least one cell by: determining that the at least one cell is labeled for partial energy savings; and setting the energy saving configuration to reduce energy to at least one component associated with the at least one cell.

The method may set the energy saving configuration to reduce energy to the at least one component associated with the at least one cell by: setting the energy saving configuration to reduce transmit energy of a power amplifier of a radio unit of the at least one cell.

The method may set the energy saving configuration to reduce energy to the at least one component associated with the at least one cell by: setting the energy saving configuration to reduce number of transmission antennas being utilized by the at least one cell.

The method may generate the at least one network energy saving model by: employing at least one artificial intelligence mechanism to train the at least one network energy saving model from the historical network performance and topology information regarding the cellular network.

The method may generate the at least one network energy saving model by: receiving manual input from an administrator defining the at least one network energy saving model.

The method may generate the at least one network energy saving model by: receiving vendor-generated functions that define the at least one network energy saving model.

The method may generate the at least one network energy saving model by: generating a separate network energy saving model for each separate network function of a plurality of network functions for the cellular network.

The method may generate the at least one network energy saving model by: generating a separate network energy saving model for each separate subset of cells of a plurality of cells in the cellular network.

The method may further comprise: modifying the energy saving configuration for the at least one cell to maintain a minimum quality of experience threshold for the cellular network.

The method may further comprise: storing a predicted load on a primary cell of the cellular network; obtaining an actual load on the primary cell after utilization of the energy saving configuration for the at least one cell; and employing the predicted load and the actual load on the primary cell as feedback to modify the at least one network energy saving model.

A system may be summarized as comprising: an energy saving model manager and a network energy saving configuration manager. The energy saving model manager may be configured to: obtain historical network performance and topology information regarding cells of a cellular network; generate at least one network energy saving model from the historical network performance and topology information; obtain current network performance and topology information regarding the cells of the cellular network; employ the at least one network energy saving model on the current network performance and topology information to set an energy saving configuration for at least one cell in the cellular network. The network energy saving configuration manager may be configured to: utilize the energy saving configuration to reduce energy utilized by the at least one cell.

The energy saving model manager of the system may employ the at least one network energy saving model on the current network performance and topology information to set the energy saving configuration for the at least one cell by being further configured to: determine if offloading of user devices from the at least one cell to a primary cell is possible; and in response to determining that offloading of user devices from the at least one cell to the primary cell is possible: set the energy saving configuration for the at least one cell to power down; and label the user devices for offloading from the at least one cell to the primary cell.

The energy saving model manager of the system may employ the at least one network energy saving model on the current network performance and topology information to set the energy saving configuration for the at least one cell by being further configured to: determine that the at least one cell is labeled for full energy savings; and set the energy saving configuration for the at least one cell to power down.

The energy saving model manager of the system may employ the at least one network energy saving model on the current network performance and topology information to set the energy saving configuration for the at least one cell by being further configured to: determine that the at least one cell is labeled for partial energy savings; and set the energy saving configuration to reduce energy to at least one component associated with the at least one cell.

The energy saving model manager of the system may generate the at least one network energy saving model from the historical network performance and topology information by being further configured to: employ at least one artificial intelligence mechanism to train the at least one network energy saving model from the historical network performance and topology information regarding the cellular network.

A computing device may be summarized as comprising: a memory that stores computer instructions; and a processor system that executes the computer instructions to: obtain historical network performance and topology information regarding a cellular network; generate at least one network energy saving model from the historical network performance and topology information; obtain current network performance and topology information regarding at least one cell of the cellular network; employ the at least one network energy saving model on the current network performance and topology information to set an energy saving configuration for the at least one cell; and utilize the energy saving configuration to reduce energy consumption by the at least one cell.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
identifying at least one cell of a cellular network;
obtaining historical network performance and topology information regarding the cellular network;
generating at least one network energy saving model from the historical network performance and topology information;
obtaining current network performance and topology information regarding the cellular network;
employing the at least one network energy saving model on the current network performance and topology information to set an energy saving configuration for the at least one cell; and
utilizing the energy saving configuration to reduce energy utilized by the at least one cell.

2. The method of claim 1, wherein employing the at least one network energy saving model on the current network performance and topology information to set the energy saving configuration for the at least one cell comprises:
determining if offloading of user devices from the at least one cell to a primary cell is possible; and
in response to determining that offloading of user devices from the at least one cell to the primary cell is possible:
setting the energy saving configuration for the at least one cell to power down; and
labeling the user devices for offloading from the at least one cell to the primary cell.

3. The method of claim 1, wherein employing the at least one network energy saving model on the current network performance and topology information to set the energy saving configuration for the at least one cell comprises:
determining if a first current load on the at least one cell and a second current load on a primary cell associated with the selected cell match a predicted amount of load; and
in response to determining that the first current load on the at least one cell and the second current load on the primary cell associated with the selected cell match the predicted amount of load:
setting the energy saving configuration for the at least one cell to power down; and
labeling the user devices for offloading from the at least one cell to the primary cell.

4. The method of claim 1, wherein employing the at least one network energy saving model on the current network performance and topology information to set the energy saving configuration for the at least one cell comprises:
determining that the at least one cell is labeled for full energy savings; and
setting the energy saving configuration for the at least one cell to power down.

5. The method of claim 1, wherein employing the at least one network energy saving model on the current network performance and topology information to set the energy saving configuration for the at least one cell comprises:
determining that the at least one cell is labeled for partial energy savings; and
setting the energy saving configuration to reduce energy to at least one component associated with the at least one cell.

6. The method of claim 1, wherein setting the energy saving configuration to reduce energy to the at least one component associated with the at least one cell comprises:
setting the energy saving configuration to reduce transmit energy of a power amplifier of a radio unit of the at least one cell.

7. The method of claim 1, wherein setting the energy saving configuration to reduce energy to the at least one component associated with the at least one cell comprises:
setting the energy saving configuration to reduce number of transmission antennas being utilized by the at least one cell.

8. The method of claim 1, wherein generating the at least one network energy saving model comprises:
employing at least one artificial intelligence mechanism to train the at least one network energy saving model from the historical network performance and topology information regarding the cellular network.

9. The method of claim 1, wherein generating the at least one network energy saving model comprises:
receiving manual input from an administrator defining the at least one network energy saving model.

10. The method of claim 1, wherein generating the at least one network energy saving model comprises:
receiving vendor-generated functions that define the at least one network energy saving model.

11. The method of claim 1, wherein generating the at least one network energy saving model comprises:
generating a separate network energy saving model for each separate network function of a plurality of network functions for the cellular network.

12. The method of claim 1, wherein generating the at least one network energy saving model comprises:
generating a separate network energy saving model for each separate subset of cells of a plurality of cells in the cellular network.

13. The method of claim 1, further comprising:
modifying the energy saving configuration for the at least one cell to maintain a minimum quality of experience threshold for the cellular network.

14. The method of claim 1, further comprising:
storing a predicted load on a primary cell of the cellular network;
obtaining an actual load on the primary cell after utilization of the energy saving configuration for the at least one cell; and
employing the predicted load and the actual load on the primary cell as feedback to modify the at least one network energy saving model.

15. A system, comprising:
an energy saving model manager configured to:
obtain historical network performance and topology information regarding cells of a cellular network;
generate at least one network energy saving model from the historical network performance and topology information;
obtain current network performance and topology information regarding the cells of the cellular network;
employ the at least one network energy saving model on the current network performance and topology information to set an energy saving configuration for at least one cell in the cellular network; and
a network energy saving configuration manager configured to:
utilize the energy saving configuration to reduce energy utilized by the at least one cell.

16. The system of claim 15, wherein the energy saving model manager employs the at least one network energy saving model on the current network performance and topology information to set the energy saving configuration for the at least one cell by being further configured to:
determine if offloading of user devices from the at least one cell to a primary cell is possible; and
in response to determining that offloading of user devices from the at least one cell to the primary cell is possible:
set the energy saving configuration for the at least one cell to power down; and
label the user devices for offloading from the at least one cell to the primary cell.

17. The system of claim 15, wherein the energy saving model manager employs the at least one network energy saving model on the current network performance and topology information to set the energy saving configuration for the at least one cell by being further configured to:
determine that the at least one cell is labeled for full energy savings; and
set the energy saving configuration for the at least one cell to power down.

18. The system of claim 15, wherein the energy saving model manager employs the at least one network energy saving model on the current network performance and topology information to set the energy saving configuration for the at least one cell by being further configured to:
determine that the at least one cell is labeled for partial energy savings; and
set the energy saving configuration to reduce energy to at least one component associated with the at least one cell.

19. The system of claim 15, wherein the energy saving model manager generates the at least one network energy saving model from the historical network performance and topology information by being further configured to:
employ at least one artificial intelligence mechanism to train the at least one network energy saving model from the historical network performance and topology information regarding the cellular network.

20. A computing device, comprising:
a memory that stores computer instructions; and
a processor system that executes the computer instructions to:
obtain historical network performance and topology information regarding a cellular network;
generate at least one network energy saving model from the historical network performance and topology information;
obtain current network performance and topology information regarding at least one cell of the cellular network;
employ the at least one network energy saving model on the current network performance and topology information to set an energy saving configuration for the at least one cell; and
utilize the energy saving configuration to reduce energy consumption by the at least one cell.
